(19) United States
(12) Patent Application Publication
(10) Pub. No.: US 2004/0037713 A1
(43) Pub. Date: Feb. 26, 2004

(54) Fuel transporting device for a motor vehicle

(76) Inventors: Peter Schelhas, Stuttgart (DE); Asta Reichl, Stuttgart (DE); Stephan Kleppner, Bretten (DE); Michael Kuehn, Bietigheim-Bissingen (DE); Mathias Rollwagen, Ditzingen (DE); Hans-Peter Braun, Reinfrizhausen (DE); Hans-Joerg Fees, Bietigheim-Bissingen (DE); Dieter Schreckenberger, Marbach (DE); Thomas Wieland, Stuttgart (DE); Jochen Rose, Hemmingen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/381,274

(22) PCT Filed: Jul. 25, 2002
(86) PCT No.: PCT/DE02/02738

(30) Foreign Application Priority Data
Jul. 25, 2001 (DE) 1 01 36 185.8

(51) Int. Cl. F04B 23/00; B01D 25/00

(52) U.S. Cl. 417/313; 417/423.3; 210/416.4

(57) ABSTRACT

The fuel feed system has a feed unit (22), which has having an electric motor (32) as a drive mechanism and a pumping part (34) driven by the electric motor; the pumping part (34) is disposed offset from the electric motor (32), in the direction of the pivot axis (33) of the electric motor. A filter (24) is disposed beside the feed unit (22) and fuel pumped by the pumping part (34) flows through it. The feed unit (22) and the filter (24) are disposed in separate chambers (10, 20) of a common housing (16), between which chambers there is an overflow opening (60) for the fuel pumped by the pumping part (34). The housing (16) is tightly closed by means of a cap (26). The electric motor (32) and the pumping part (34) are inserted as separate structural units into a chamber (10) of the housing (16) and are braced against one another by at least one resilient element (58) in the direction of the pivot axis (33) of the electric motor (32).

### PRIOR ART

The invention based on a fuel feed system for a motor vehicle as generically defined by the preamble to claim 1.

One such fuel feed system is known from German Patent Disclosure DE 42 42 242 A1. This fuel feed system has a feed unit with an electric motor as a drive mechanism and with a pumping part driven by the electric motor. The pumping part is offset toward the electric motor in the direction of the pivot axis of the electric motor. The fuel feed system also has a filter, which is disposed beside the feed unit and through which fuel pumped by the feed unit flows. The fuel feed system has a housing, in which the feed unit and the filter are disposed in separate chambers. Between the chambers, there is an overflow opening for the fuel pumped by the feed unit. The housing is tightly closed with a cap. A disadvantage of the known fuel feed system is that the pumping part is integrated with the housing, so that for various embodiments of a pumping part, separate versions of the housing are also needed. This makes both production and storage of the fuel feed system complicated and expensive.

### ADVANTAGES OF THE INVENTION

The fuel feed system of the invention having the characteristics of the body of claim 1 has the advantage over the prior art that one uniform housing can be used for various embodiments of the pumping part, since the pumping part is inserted as a separate structural unit into the housing. The electric motor, too, can be used for various versions of the pumping part, so that overall, simple and economical production of the fuel feed system is made possible.

In the dependent claims, advantageous embodiments and refinements of the fuel feed system of the invention are disclosed.

The embodiment of claim 2 is advantageous because it assures a contact between the electric motor and the pumping part, regardless of production tolerances and thermal expansions.

The embodiment of claim 4 is also advantageous, since it assures a secure disposition of the filter in the housing regardless of production tolerances and thermal expansions.

The embodiment of claim 6 is also advantageous, because it makes a favorable flow course possible for the fuel pumped by the pumping part.

The embodiment of claim 7 is advantageous as well, since it makes simple electrical contacting of the electric motor possible.

It is advantageous to dispose a jet pump on the common housing of the fuel feed system, because this simplifies assembly, and now the fuel feed system need merely be inserted as a complete unit into the fuel tank. With the aid of a suction line, the jet pump can always aspirate fuel from the vicinity of a lowest point on the bottom of the fuel tank, making it possible to pump fuel into the storage container until the fuel tank is nearly empty.

It is also advantageous to provide at least one further jet pump, which is driven by fuel that is at high pressure from the fuel feed system, for instance via a pressure regulating valve or an opening in a cap, since in this way a high pumping capacity of the further jet pump can be attained.

### DRAWING

Two exemplary embodiments of the invention are shown in the drawing and are explained in further detail in the ensuing description.

FIG. 1 shows a first exemplary embodiment of a fuel feed system for a motor vehicle in a longitudinal section;

FIG. 2 shows a section taken along the line II-II in FIG. 1; and

FIG. 3 shows a second exemplary embodiment of a fuel feed system for a motor vehicle in a longitudinal section.

### DESCRIPTION OF THE EXEMPLARY EMBODIMENT

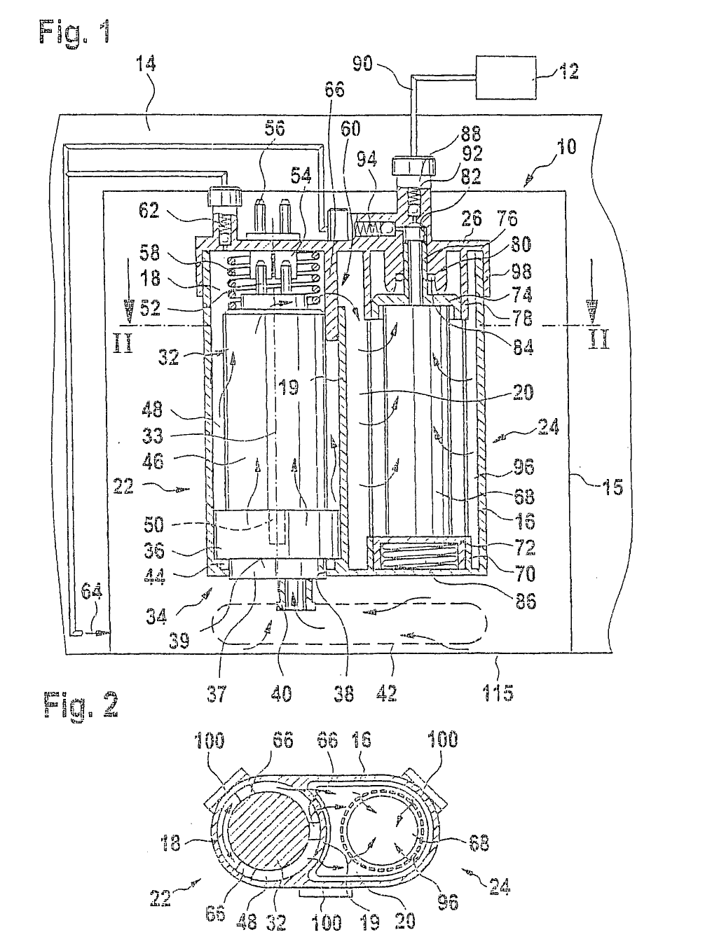

In FIGS. 1 and 2, a fuel feed system 10 for a motor vehicle is shown. The motor vehicle has an internal combustion engine 12 with an injection system, through which fuel is injected into the cylinders of the engine 12. The fuel feed system 10 is disposed in a fuel tank 14 of the motor vehicle. A cup-shaped storage container 15 can be disposed in the fuel tank 14; it has a substantially smaller volume than the fuel tank 14, and the fuel feed system 10 is disposed in it. The storage container 15 is not necessary, if a cup-shaped indentation is embodied in the bottom 115 of the fuel tank 14. The fuel feed system 10 has a housing 16, in which two separate cup-shaped chambers 18 and 20 disposed side by side are formed, divided from one another by a chamber wall 19. A feed unit 22, described in further detail hereinafter, is disposed in the first chamber 18, and a filter 24, also described in further detail hereinafter, is disposed in the second chamber 20. The housing 16 is tightly closed on top with a cap 26. The first chamber 18 of the housing 16 is embodied as circular in cross section, for instance, but can also have an arbitrary other cross-sectional shape. The housing 16 overall has a rounded, elongated cross-sectional shape, and the second chamber 20 of the housing 16 is embodied as complementary in cross section to the first chamber 18.

The feed unit 22 has an electric motor 32 as its drive mechanism and a pumping part 34 driven by the electric motor. The electric motor 32 and the pumping part 34 are inserted as separate structural units into the chamber 18 of the housing 16 from the top. The pumping part 34 is disposed below the electric motor, offset toward the electric motor 32 in the direction of the pivot axis 33 of the electric motor 32. The pumping part 34 has a housing 36, in which at least one pumping element is disposed that is driven to revolve by the electric motor 32. The pumping part 34 can be embodied as a flow pump, in particular as a peripheral pump or as a side-channel pump. Alternatively, the pumping part 34 can be embodied as a positive displacement pump, such as a roller-cell pump or as a geared pump. On the bottom of the first chamber 18, in which the pumping part 34 is disposed, the housing 16 has an opening 38, through a portion 37 of the housing 36 of the pumping part 34 of reduced cross section protrudes outward, and on the end of which portion an intake stub 40 is disposed. A prefilter 42 can be slipped onto the intake stub 40. The pumping part 34, when in operation, aspirates fuel via the intake stub 40. The pumping part 34 is embodied as at least virtually circular in cross section, and its outside diameter is only slightly smaller than the inside diameter of the chamber 18. An elastic sealing ring 44 is fastened between the portion 37 of the pumping part housing 36 and the opening 38, and the chamber 18 is sealed off by it. In the direction of the pivot axis 33, the pumping part 34 is seated on the bottom of the chamber 18, with an annular shoulder 39 of reduced diameter formed at the transition to the portion 37 of the pumping part. It can also be provided that the pumping part 34 is seated with its annular shoulder 39 on the sealing ring 44, which provides a disconnection in terms of noise between the pumping part 34 and the housing 16.

The electric motor 32 has its own housing 46, which is for instance cylindrical, and its outer diameter is smaller than that of the pumping part 34 and than the inside diameter of the chamber 18. An annular chamber 48 thus remains between the electric motor 32 and the wall of the chamber 18. A shaft 50 protrudes out of the housing 46 of the electric motor 32 toward the pumping part and is connected to the pumping element of the pumping part 34 by rotational engagement. From the top of the electric motor 32, pointing away from the pumping part 34, electrical terminals 52, embodied for instance as plug prongs, protrude from the pumping part housing 46. Corresponding electrical counterpart terminals 54 are disposed on the cap 26, embodied for instance as receptacle, which in turn are connected to electrical terminals 56 disposed on the outside of the cap 26. When the cap 26 is placed on the housing 16, the electrical terminals 52 of the electric motor 32 are put together with the electrical counterpart terminals 54 of the cap 26. The electrical terminals 52 of the electric motor 32 can also be put together in some other way with the counterpart terminals 54 on the cap 26, for instance in the form of an insulation displacement connection. Alternatively, it can be provided that the electrical terminals 52 of the electric motor 32 and/or the counterpart terminals 54 on the cap 26 are embodied resiliently and rest against one another by initial tension.

A prestressed resilient element 58, for instance in the form of a helical compression spring, is disposed between the cap 26 and the face end, toward it, of the electric motor 32; by means of this spring, the electric motor 32 and the pumping part 34 are braced against one another in the direction of the pivot axis 33. By means of the resilient element 58, production tolerances and different thermal expansions of the housing 16, cap 26, electric motor 32 and pumping part 34 are compensated for, and it is assured that the electric motor 32 and the pumping part 34 will always be in contact with one another.

The chamber wall 19 that separates the chambers 18, 20 from one another does not extend all the way to the cap 26, so that an overflow opening 60 remains between its end and the cap 26, through which opening the fuel, pumped by the pumping part 34 and flowing upward through the annular chamber 48 between the electric motor 32 and the chamber 18 reaches the second chamber 20. A pressure reduction valve 62 is disposed on the cap 26, in the region of the first chamber 18, and when a pressure in the chamber 18 set at this valve is exceeded, this valve opens and allows fuel to flow out of the chamber 18. The quantity of fuel diverted by the pressure reduction valve 62 can be delivered as a propellant quantity to a jet pump 64, which pumps fuel out of the fuel tank 14 into the storage container 15. The pumping part 34 aspirates fuel from the storage container 15 via an intake stub 40.

The electric motor 32 is braced in the radial direction, relative to its pivot axis 33, in the first chamber 18 via a plurality of support elements 66 distributed over the circumference of the electric motor. For instance, three support elements 66 distributed at uniform intervals over the circumference of the electric motor 32 may be provided. The support elements 66 are preferably embodied elastically, so that a disconnection in terms of noise is achieved between the electric motor 32 and the housing 16 is achieved. The support elements 66 can be secured to the housing 16 or to the housing 46 of the electric motor 32. Alternatively to the above embodiment of the electric motor 32, in which the electric motor has the housing 46, it can also be provided that the electric motor 32 has no housing of its own, and that the walls of the first chamber 18 act as the housing for the electric motor 32. In that case, fuel pumped by the pumping part 34 flows through the electric motor 32.

The filter 24 disposed in the second chamber 20 has a hollow-cylindrical filter insert 68, whose longitudinal axis 69 is disposed at least approximately parallel to the pivot axis 33 of the electric motor 32. The filter insert 68 is inserted tightly by its lower end into a receptacle 70 on the bottom of the second chamber 20. The receptacle 70 is embodied as an annular rib protruding from the bottom of the chamber 20. The filter insert 68 has a bearer 72 on its lower end that is tightly inserted into the receptacle 70. The filter insert 68 also has a bearer 74 on its upper end, onto which a connection stub 76 is formed. Between the bearers 72, 74, the filter insert 68 has coiled or folded filter cloth. The cap 26 has an inward-protruding hollow-cylindrical extension 78, in the region of the second chamber 20, that receives the bearer 74 of the filter insert 68. Inside the extension 78 and coaxially to it, a further extension 80 is disposed on the cap 26, protruding into the chamber 20 and having a bore 82. The bore 82 has a larger diameter toward its orifice in the chamber 20 than in the cap 26. The connection stub 76 protrudes into the bore 82, and between the connection stub 76 and the larger-diameter region of the bore 82, an elastic sealing ring 84 is fastened in place. A prestressed resilient element 86, for instance in the form of a helical compression spring, is disposed between the bottom of the chamber 20 and the lower bearer 72, inserted into the receptacle 70, of the filter insert 68. By means of the resilient element 86, the filter insert 68 is pressed with its connection stub 76 into the bore 82 of the cap 26, whereupon the filter insert 68 rests with its upper bearer 74 on the lower edge of the extension 80. By means of the resilient element 86, production tolerances and thermal expansions of the housing 16, cap 26, and filter insert 68 are compensated for.

The bore 82 discharges on the outside of the cap 26 in a connection stub 88 disposed on the cap, and a line 90 leading to the injection system of the engine 12 is connected to this connection stub. A check valve 92 that is open toward the injection system is disposed in the connection stub 88. Upstream of the check valve 92, a branch leads away from the bore 82, and a pressure regulating valve 94 is disposed in it. By means of the pressure regulating valve 94, a predetermined pressure for the fuel delivered to the injection system is set. If the pressure set by the pressure regulating valve 94 is exceeded, this valve opens and causes some of the fuel to flow out upstream of the check valve 92. The fuel quantity diverted by the pressure regulating valve 94 can be delivered to the jet pump 64 as a propellant quantity.

Between the outer jacket of the filter insert 68 and the second chamber 20, an annular chamber 96 remains, which is reached by the fuel pumped by the pumping part 34 and flowing through the overflow opening 60. The fuel flows radially inward through the filter insert 68 and arrives, cleaned, through the connection stub 76, the bore 82, and the connection stub 88, in the line 90 and through that reaches the injection system of the engine 12. The filter insert 68 is preferably dimensioned such that for the entire life of the motor vehicle, it need not be changed.

The cap 26 has a collar 98, which fits over the housing 16 and is tightly joined to the housing 16. Preferably, the collar 98 of the cap 26 is glued or welded to the housing 16. For example, the cap 26 can be joined to the housing 16 by ultrasonic welding or laser welding. The housing 16 and the cap 26 are preferably of plastic and can be produced by injection molding. One or more retaining elements 100 can be disposed on the housing 16, and by means of them the housing 16 and thus the fuel feed system 10 can be secured in the storage container 15 or in the fuel tank 14. The retaining elements 100 can for instance be embodied as detent elements.

The housing 16 with the cap 26, along with the electric motor 32 and the filter 24, can be used in a uniform design for different embodiments of the fuel feed system 10; depending on the requisite feed pressure to be generated and/or pumping quantity to be furnished, a different pumping part 34 that meets these requirements can be used.

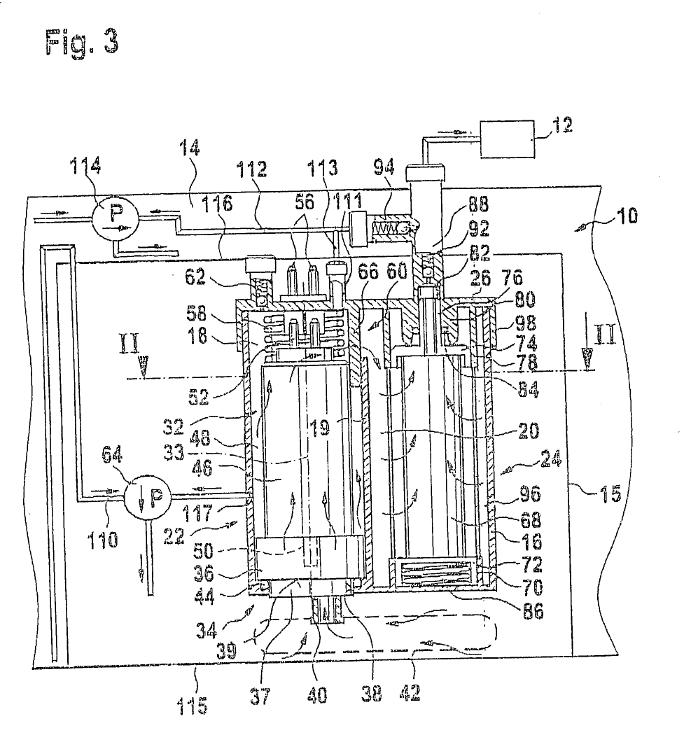

In the fuel feed system of FIG. 3, the parts that remain the same or function the same as in the fuel feed system of FIG. 1 are identified by the same reference numerals.

The fuel feed system of FIG. 3 differs from the fuel feed system of FIG. 1 in that the pressure regulating valve 94 is disposed downstream of the check valve 92 in the line 90. Also, the jet pump 64 is disposed inside the storage container 15, for instance on the housing 16. The jet pump 64 is supplied with fuel at high pressure, as a propellant quantity, via an opening 117 that is disposed on the circumference of the housing 16 and on a compression side of the pumping part 34. The jet pump 64 aspirates fuel, by means of a suction line 110 that is extended for instance along an edge 116 of the storage container 15, from the vicinity of a bottom 115 of the fuel tank 14 and pumps fuel into the storage container 15. The length of the suction line 110 is adapted to the particular fuel tank 14 involved. Through the suction line 110, the aspiration of the fuel can be done in the vicinity of a lowest point of the bottom 115 of the fuel tank 14 regardless of the location of the storage container 15 inside the fuel tank 14, so that it is possible to pump fuel into the storage container 15 until the fuel tank 14 is virtually empty. However, it is also possible for the jet pump 64 to be disposed at least in part on the compression side of the pumping part 34 via the opening 117 in the housing 16.

A pressure reduction valve 62 may be disposed on the cap 26, in the region of the first chamber 18; when a pressure in the chamber 18 set at this valve is exceeded, it opens and causes fuel to flow out from the chamber 18 into the fuel tank 14.

It is also possible, however, in addition to the jet pump 64 for at least one further jet pump 114 to be provided, which is disposed for instance outside the storage container 15 and serves to pump fuel to the storage container 15 via a cradle of a fuel tank 14 embodied as a cradle tank. The quantity of fuel diverted by the pressure regulating valve 94 can be delivered as a propellant quantity to the at least one further jet pump 114. This at least one further jet pump 114 can also be supplied with fuel at high pressure as a propellant quantity by means of an opening 111 via a branch line 113. The opening 111 is provided in the cap 26, for instance in the region of the first chamber 18. Since the fuel in the region of the first chamber 18 is at high pressure, the at least one jet pump 114, driven with fuel via the opening 111, can produce a high pumping capacity.

1. A fuel feed system for a motor vehicle, having a feed unit (22), which has an electric motor (32) as its drive mechanism and a pumping part (34), driven by the electric motor, the pumping part (34) being disposed in the direction of the pivot axis (33) of the electric motor (32), offset from the electric motor, and having a filter (24), which is disposed beside the feed unit (22) and which has a flow through it of the fuel pumped by the pumping part (34), the feed unit (22) and the filter (24) being disposed in separate chambers (18, 20) of a common housing (16), between which chambers there is an overflow opening (60) for the fuel pumped by the pumping part (34), and the housing (16) being closed tightly by means of a cap (26), characterized in that the electric motor (32) and the pumping part (34) are inserted as separate structural units into a chamber (18) of the housing (16).

2. The fuel feed system of claim 1, characterized in that the electric motor (32) and the pumping part (34) are braced against one another in the housing (16) in the direction of the pivot axis (33) of the electric motor (32) by means of at least one resilient element (58).

3. The fuel feed system of claims 1 or 2, characterized in that the at least one resilient element (58) is fastened between the electric motor (32) and the cap (26).

4. The fuel feed system of one of claims 1-3, characterized in that the filter (24) is braced between the housing (16) and the cap (26) by means of at least one resilient element (86).

5. The fuel feed system of one of claims 1-4, characterized in that the pumping part (34) and the electric motor (32) each have their own housing (36, 46, respectively).

6. The fuel feed system of claim 5, characterized in that the fuel pumped by the pumping part (34) flows through an annular chamber (48), formed between the housing (46) of the electric motor (32) and a chamber wall that defines the chamber (18) in which the feed unit (22) is disposed.

7. The fuel feed system of one of claims 1-6, characterized in that the electric motor (32) has electrical terminals (52), which are put together, preferably by insertion one into the another, with corresponding electrical counterpart terminals (54) on the inside of the cap (26), and that further electrical terminals (56) connected to the counterpart terminals (54) are disposed on the outside of the cap (26).

8. The fuel feed system of claim 1, characterized in that a jet pump (64) is disposed in or on the housing (16) and by means of a suction line (110) aspirates fuel from the vicinity of a bottom (115) of the fuel tank (14).

9. The fuel feed system of claim 1, characterized in that an opening (111) for the at least indirect connection to at least one further jet pump (114) is provided in the cap (26).

10. The fuel feed system of claim 1, characterized in that a pressure regulating valve (94) is provided for at least indirect connection to at least one further jet pump (114).
